(19) United States
(12) Patent Application Publication
(10) Pub. No.: US 2004/0205567 A1
(43) Pub. Date: Oct. 14, 2004

(54) Method and system for imbedding XML fragments in XML documents during run-time

(76) Inventor: Andrew S. Nielsen, Redmond, WA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/055,595

(22) Filed: Jan. 22, 2002

(51) Int. Cl. G06F 17/24

(52) U.S. Cl. 715/513; 715/530

(57) ABSTRACT

A method for dynamically modifying a mark-up language document (e.g., an XML test suite file) during runtime with data unavailable when the mark-up language document is created. A mechanism is also provided for allowing one to specify a location in the mark-up language document for inserting the data.

### FIELD OF THE INVENTION

The present invention relates generally to the testing of Web services, and more particularly, to a method and system for imbedding XML fragments in XML documents during run-time.

### BACKGROUND OF THE INVENTION

With the explosive growth of business to business (B2B) eCommerce, the Internet presents incredible opportunities for businesses of all sizes. For example, business to business (B2B) eCommerce provides opportunities to find new customers, to streamline supply chains, to provide new services, and to secure financial gain.

Organizations that have moved their business online are already realizing significant economic and competitive gains, such as increased revenue, lowered costs, new customer relationships, innovative branding opportunities, and the creation of new lines of customer service.

Despite the outstanding growth of B2B eCommerce in the last few years, there exists a major impediment to opening up worldwide trade to those already conducting B2B eCommerce and to the businesses that are not yet players in the digital economy.

This impediment can be described as follows. Most eCommerce-enabling applications and Web services currently in place employ divergent paths to connect buyers, suppliers, marketplaces, and service providers. Without large investments in technology infrastructure, a semiconductor manufacturer in Taiwan, a furniture manufacturer in Pennsylvania, and a specialized industrial engineering firm in New Delhi can transact Internet-based business only with the global trading partners they have discovered and, of those, only the ones using the same applications and Web services. As can be appreciated, this current model is restrictive and limiting.

In order to fully open the doors to these existing and potential B2B players, successful eCommerce requires that businesses be able to 1) discover each other, 2) make their needs and capabilities known, and 3) integrate services using each businesses' preferred technology, Web services, and commerce processes.

To address this challenge, a group of technology and business leaders have come together to develop the Universal Description, Discovery and Integration specification. The UDDI specification sets forth a global, platform-independent, open framework to enable businesses to (1) discover each other, (2) define how they interact over the Internet, and (3) share information in a global registry, thereby accelerating the global adoption of B2B eCommerce. UDDI is also a building block to enable businesses to quickly, easily and dynamically find and transact with one another via their preferred applications. Participation in UDDI can help an established B2B eCommerce player expand into new markets and services or allow a company, who is new to the online space, to accelerate toward a world-class business presence.

The UDDI specifications take advantage of World Wide Web Consortium (W3C) and Internet Engineering Task Force (JETF) standards such as Extensible Markup Language (XML), HTTP, and Domain Name System (DNS) protocols. Additionally, cross platform programming features are addressed by adopting early versions of the proposed Simple Object Access Protocol (SOAP) messaging specifications found at the W3C Web site.

The UDDI specification envisions distributed Web-based information registries of Web services. These UDDI registries are used to promote and discover distributed Web services. UDDI is also a publicly accessible set of implementations of the specification that allow businesses to register information regarding Web services they offer so that other businesses can find them.

In the development of web servers that implement UDDI services, there is a need for mechanisms to test these services in order to ensure the proper operation thereof. Typically, a test suite file is written that tests the various operations supported by the Web server.

Unfortunately, the testing of web services poses several significant problems. One of these problems that are faced by testers of XML documents based web services is that often the information returned from a request cannot be determined at the time the tests are created. For example, the information may only be known at run-time after the server to be tested returns the information.

For example, a web service may support the saving of some object. The service often assigns the object a key, a tracking number, or other run-time values. The service also provides a way to look up the object (e.g., retrieve the information in the future). The testing of this service can employ a test suite file that saves the item in the first step, and when successful, looks up the previously saved item in the second step. This second step ensures that the save step executed properly.

One challenge to those devising appropriate test suite file is how to write a static test case that captures information that is not known at the time the test suite is created. This challenge is essentially a problem of timing. At the time one writes the test suite file, the run-time values of the object do not exist. The run-time values are assigned when the test is run (i.e., at run-time).

Accordingly, it would be desirable for there to be a mechanism for dynamically modifying the test suite file during runtime with data unavailable when the test suite file is created. It is also desirable for there to be a mechanism that allows the test creator to specify a location in the test suite file for inserting the data.

Based on the foregoing, there remains a need for a method that dynamically modifies a test suite file during runtime with data that is unavailable when the test suite file is created, that allows a test creator to specify where in the test suite file to insert the data, and that overcomes the disadvantages set forth previously.

### SUMMARY OF THE INVENTION

According to one embodiment of the present invention, a method for extracting data from runtime test results and for injecting the extracted data into subsequent verification calls is described.

According to one embodiment, a mechanism for modifying a mark-up language document (e.g., an XML test suite file) at run-time with data unavailable when the mark-up language document is created. The mechanism of the present invention, for example, extracts data from runtime test results (e.g., response from a server under test) and injects the extracted data into a portion of the test suite file that may be specified by the user. For example, the extracted data may be utilized in subsequent verification calls.

Other features and advantages of the present invention will be apparent from the detailed description that follows.

### BRIEF DESCRIPTION OF THE DRAWINGS

The present invention is illustrated by way of example, and not by way of limitation, in the figures of the accompanying drawings and in which like reference numerals refer to similar elements.

FIG. 1 illustrates a test infrastructure in which the mechanism of the present invention may be implemented.

FIG. 2 is block diagram illustrating in greater detail the dynamic markup language document modification module of FIG. 1 in accordance with one embodiment of the present invention.

FIG. 3 is a flow chart illustrating the steps performed by the dynamic markup language document modification mechanism of FIG. 1 for processing interactions in accordance with one embodiment of the present invention.

FIG. 4 is a flow chart illustrating the steps for replacing references in accordance with one embodiment of the present invention.

FIG. 5 illustrates an exemplary portion of a test suite file that includes interaction elements according to one embodiment of the present invention.

FIG. 6 illustrates the interaction element of FIG. 5 after an actual response has been added thereto according to one embodiment of the present invention.

FIG. 7 illustrates the test suite file of FIG. 6 after an expected response element has had its references replaced with a key value obtained at run-time according to one embodiment of the present invention.

FIG. 8 illustrates the test suite file of FIG. 7 with the actualResponse element added to the second interaction element.

FIG. 9 illustrates the test suite file of FIG. 8 with its internal representation changed to reflect the key attribute value obtained at run-time.

### DETAILED DESCRIPTION

A method for modifying a mark-up language document (e.g., an XML test suite file) at run-time with data unavailable when the mark-up language document is created is described. For example, the method of the present invention can be employed to extract data from a run-time environment and to inject the extracted data into another portion of software code (e.g., a subsequent verification call). In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

It is noted that aspects of the present invention are describe in connection with a document (e.g., a test suite file) in the Extensible Markup Language (XML). However, it is to be appreciated that the teachings of the present invention extend to other documents that are described with other mark-up languages.

### Test Infrastructure 100

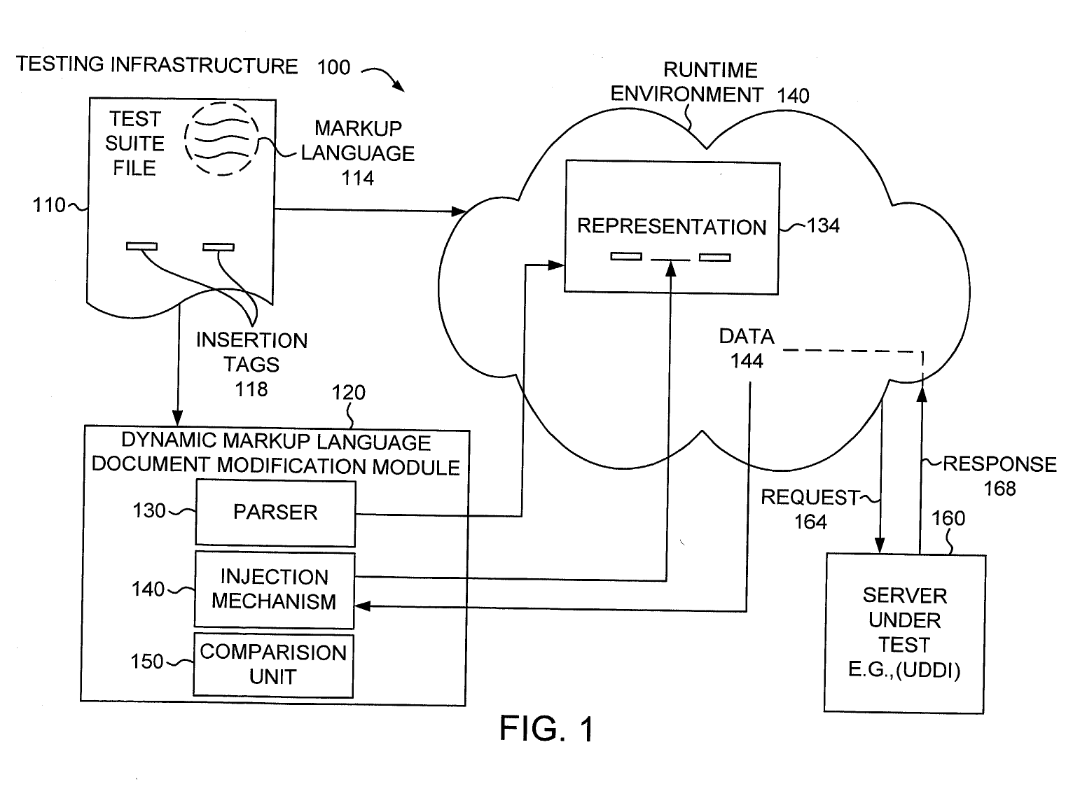

FIG. 1 illustrates a test infrastructure 100 in which the mechanism of the present invention may be implemented. The test infrastructure 100 includes a test suite file 110 that is written in a markup language (e.g., the Extensible Markup Language (XML)). The test suite file 110 includes software code for testing one or more functions of a server 160 (e.g., a UDDI server) under test. The test suite file 110 includes at least one set of insertion tags 118, which are described in greater detail hereinafter.

The test infrastructure 100 also includes a dynamic markup language document modification module (which is referred to herein as dynamic document modification module or mechanism (DDMM)) 120. The dynamic markup language document modification module 120 modifies the mark-up language document 110 (e.g., an XML test suite file) at run-time with data 144 that is unavailable when the mark-up language document 110 is created. The insertion tags 118 may be used by a creator of the test suit file 110 to specify a location in the document for inserting the data 144.

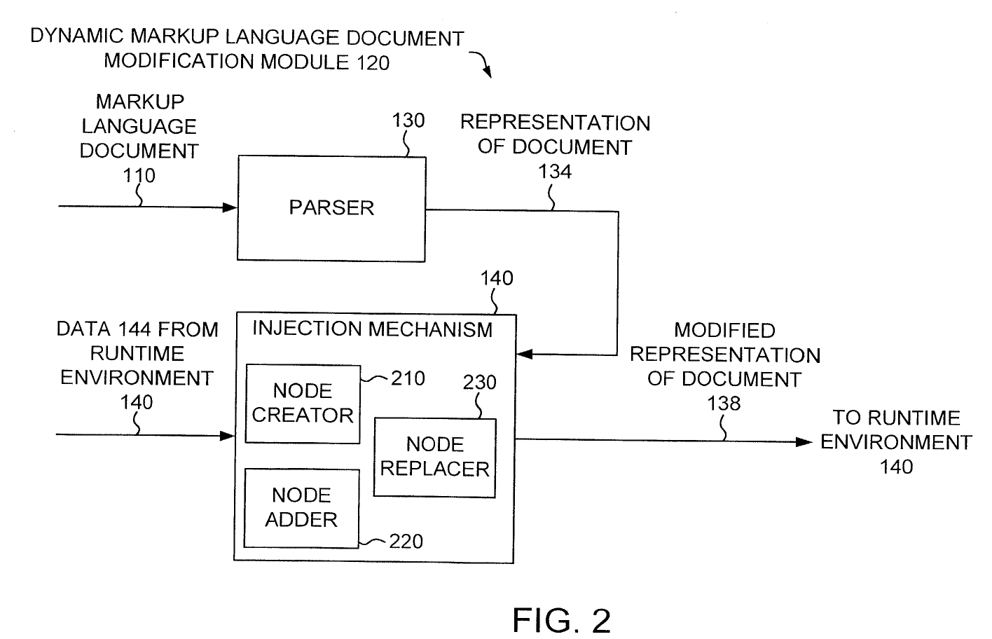

It is noted that these changes or modification are made to the representation 134 (i.e., the original XML test suite file 110 is not modified by the present invention). Furthermore, after execution, the additions or changes to the internal representation 134 of the markup language need not be saved, but may be saved in the case of UDDI. The dynamic markup language document modification module 120 is described in greater detail hereinafter with reference to FIG. 2.

The test infrastructure 100 also includes a run-time environment 140 that generates the data 144. For example, the run-time environment 140 can generate a request 164 that is directed to the server under test 160. In response, the server under test 160 generates a response 168 that may include data 144.

One example of the data 144 is a key. A key may be any unique identifier for identifying a particular object in the server (e.g., an identifier for a newly save business object or entity). It is noted that other attributes or other data may be extracted from the actual response element and injected to other portions of the test suite. These other data can include, but is not limited to, an operator name that specifies the name of the operator of the UDDI server, an authorized name that specifies the name of a publisher (e.g., a publisher that registers with a UDDI server). Examples of the data 144, which may be extracted from the response 168, are described in greater detail hereinafter.

The dynamic markup language document modification module 120 includes a parser 130 for receiving a markup language document (e.g., an XML test suite file 110) and based thereon for generating a representation 134 (e.g., an internal representation) of the document 110. For example, this internal representation 134 may be a document object model (DOM), which is a tree like data structure representation of an XML document.

The DDMM 120 also includes an injection mechanism 140 for receiving the data 144 from the run-time environment 140 and injecting the data 144 into the representation 134. The injection mechanism 140 is described in greater detail hereinafter with reference to FIG. 2.

In one embodiment, the mechanism of the present invention is implemented within an XML test infrastructure. For example, in testing UDDI servers, “save” calls return the same form of information that is returned by the “get” calls. To test whether a “save” request is successful, one first performs a “save” request followed by a “get” request. In this manner, the information that is saved by UDDI server in response to the “save” request may be compared to the information provided by the server in response to a “get” request. In this manner, the proper operation of the “save” request may be verified.

### DDMM 120

FIG. 2 is block diagram illustrating in greater detail the DDMM 120 of FIG. 1 in accordance with one embodiment of the present invention. Specifically, FIG. 2 illustrates in greater detail the injection mechanism 140 of the DDMM 120. The injection mechanism 140 receives the representation 134 of the document and the data 144 from the run-time environment 140. Based on these inputs, the injection mechanism 140 generates a modified representation 138 of the document that is sent to the run-time environment for further execution.

The injection mechanism 140 includes a node creator 210 for creating a new node with the data 144. The injection mechanism 140 also includes a node adder 220 that adds the newly created node to the location in the tree (e.g., internal DOM representation) specified by the location of the insertion tags 118. The injection mechanism 140 also includes a node replacer 230 for removing the node that existed prior to the insertion of the new node.

### Operation of a UDDI Server

An example of how web services are offered and found is now described. First, a provider of goods or services first registers with a server, such as a UDDI server. The provider, for example, registers with a UDDI server and uses a save request to save information regarding the business entity to the server. This information can include, the business entity, name of the business, contact person, contact information, a list of goods or services provided, a description of each of the goods or services, etc.

Second, a consumer searches a UDDI server for business that may be able to provide a particular good or services. For example, a consumer can use a “find” request to receive a list of keys (e.g. globally unique identifier; GUID) of business that may be able to supply the good or service.

Next, the consumer can then use a “get” request with a particular key to obtain further information about a particular business (e.g., a supplier).

The consumer can then make contact with the supplier and utilize other E-commerce services, such as request for quote and purchase order services, to proceed with a business transaction.

### Requests for UDDI Server

Universal Description and Discovery Interface (UDDI) specifies an XML/SOAP based web service. One important aspect to test is to determine whether parties can successfully register with a UDDI server. In UDDI, there are four types of requests: 1) a find request, 2) a get request, 3) a save request, and a delete request. A find request obtains an abbreviated version of an object. A get request obtains a non-abbreviated version of an object or entity. A save request saves an object to a server. A delete request deletes a specified object from the server.

During the execution of a save request, the server assigns the information being save a key. The key can be, for example, a globally unique identifier (GUID) that a server assigns to a saved object. When a save request leaves a GUID field blank, the server assigns a GUID to the object being save and returns the GUID in a response. The GUID is an example of data 144 that is not known at the time that the test file is written and that may be added or inserted into the internal representation 134 of the test file at run-time

### Test Structure

Test suite files 110 are typically structured in the following way. A test file 1110 includes three items: 1) a setup element, 2) an interactions element, and 3) a tear down element. The setup element and tear down element are well-known to those of ordinary skill in the art and are not described in greater detail hereinafter. The interaction section includes a plurality of interaction elements. In this example, the interaction includes a request, which is sent to the service, and an expectedResponse element, which is used to determine the success of the request.

The processing performed by the DDMM 120 according to one embodiment of the present invention is now described. First, a test request 164 is sent to a server under test 160. Second, a response 168 to test request is received from the server 160. Third, the representation 134 is modified by the response168. Preferably, the entire response is added to the representation 134.

As described previously, the DDMM 120 of the present invention modifies an internal representation 134 of the test file or suite. For example, the internal representation 134 may be a data structure (e.g., a XML tree) that represents the test suite.

Modifying the representation 134 with the response 168 can involve the sub-steps of 1) creating an actual response node, 2) filling the actual response node with data from the response 168, and 3) adding the actual response node to the representation (e.g., to a DOM XML tree). Fourth, a portion of the response 168 is injected as specified by the reference tags 118 (e.g., insertion tags) by employ a reference technology. For example, this step can involve replacing the reference element with at least a portion of the actual response node.

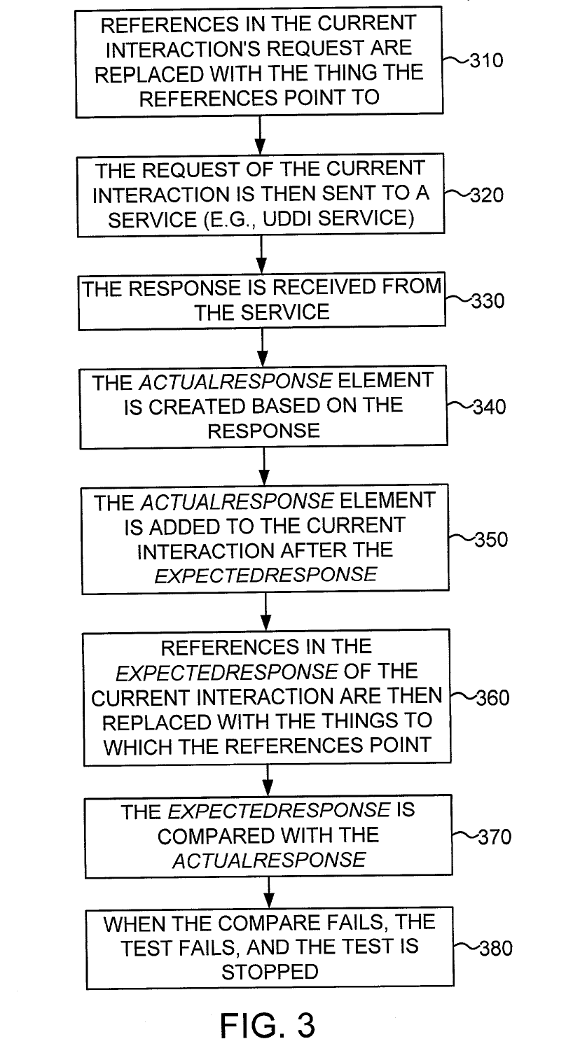

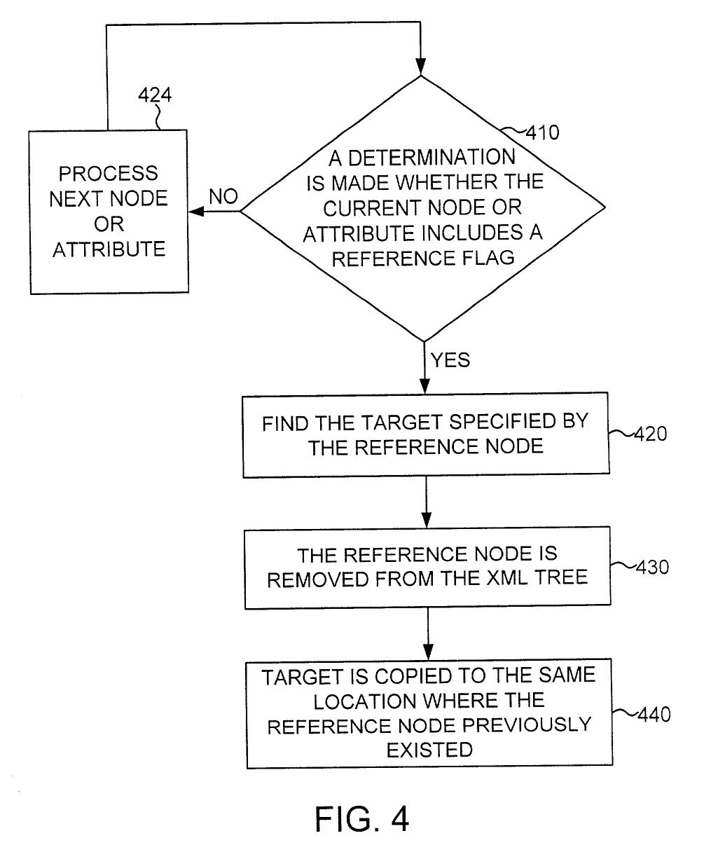

Specifically, FIG. 3 is a flow chart illustrating the steps performed by the DDMM 120 of FIG. 1 for processing interactions in accordance with one embodiment of the present invention. Prior to the steps illustrated in FIG. 3, the following steps may be performed. First, a markup document (e.g., an XML test suite file) is received and read by the parser 130. Second, the parser 130 generates an internal representation (e.g., a DOM representation) of the test suite file. The interaction processing, which is described in FIG. 3, and the replacement processing, which is described in FIG. 4, are then performed on the internal representation 134.

### Interaction Processing

For each interaction x in interactions, the following steps are performed. In step 310, the references in the current interaction's request are replaced with the thing the references point to. This step is described in greater detail hereinafter with reference to FIG. 4. A technology, such as Xpath, may be utilized for this purpose. One aspect of the present invention is the use of a referencing technology, such as Xpath for referencing a portion of the same document (i.e., a portion internal to the document). In the prior art, the referencing technology has been generally limited to referencing a portion of a document external to the document where the reference exists. For example, an Xpath reference in a first document is typically utilized to print a portion of a second document.

In step 320, the request of the current interaction is then sent to the service (e.g., UDDI service). In step 330, the response is received from the service. In step 340, the actualResponse element is created based on the response.

In step 350, the actualResponse element is added to the current interaction after the expectedResponse.

In step 360, the references in the expectedResponse of the current interaction are then replaced with the things to which the references point. This step is described in greater detail hereinafter with reference to FIG. 4.

In step 370, the expectedResponse is compared with the actualResponse.

When the compare fails, in step 380 the test fails, and the test is stopped. The comparison step may be performed by employing a variety of different techniques. Further details concerning particular embodiments of the present invention may also be found in the following copending patent application which was filed on the same date as this application and which is hereby incorporated herein by reference. The copending application is as follows: “METHOD AND SYSTEM FOR COMPARING STRUCTURED DOCUMENTS” by inventor Andrew Nielsen.

### Replacement Processing

FIG. 4 is a flow chart illustrating the steps for replacing references in accordance with one embodiment of the present invention. For each attribute or element node in the XML tree, the following steps are performed. In step 410, a determination is made whether the current node or attribute includes a reference flag. For example, a determination may be made whether a node's name begins with a “ref:”. When the current node or attribute includes a reference flag, processing proceeds to step 420. Otherwise, when the current node or attribute does not include a reference flag, processing proceeds to step 424 where the next node or attribute is processed.

In step 420, determine or find a target specified by the reference node.

In step 430, the reference node is removed from the XML tree. In step 440, the target is copied to the same location where the reference node previously existed.

For each attribute or element node in the XML tree, the following steps are performed according to one embodiment of the present invention.

When the node's name begins with “ref:” (this node is hereinafter referred to as the source), the following steps are performed. First, the replacement module finds what the attribute or element's XPath points to (which is referred to herein as a target). Second, the replacement module removes the source node and replaces the source node with a new node of the same type (e.g., attribute or element). The name for the node is the name of the source node with the “ref:” portion removed.

When both the source and target nodes are of the same type (i.e., when both the source node and target node are attributes or when both the source nodes and target node are both elements), the value of the new node is a copy of the value in the destination.

When the source is an attribute, and the target is an element; the source attribute takes on the value of the concatenation of all text nodes in the target element. When the source is an element, and the target is an attribute; the source element contains one text node that includes the same text value that is in the target attribute.

### Exemplary Test Suite File

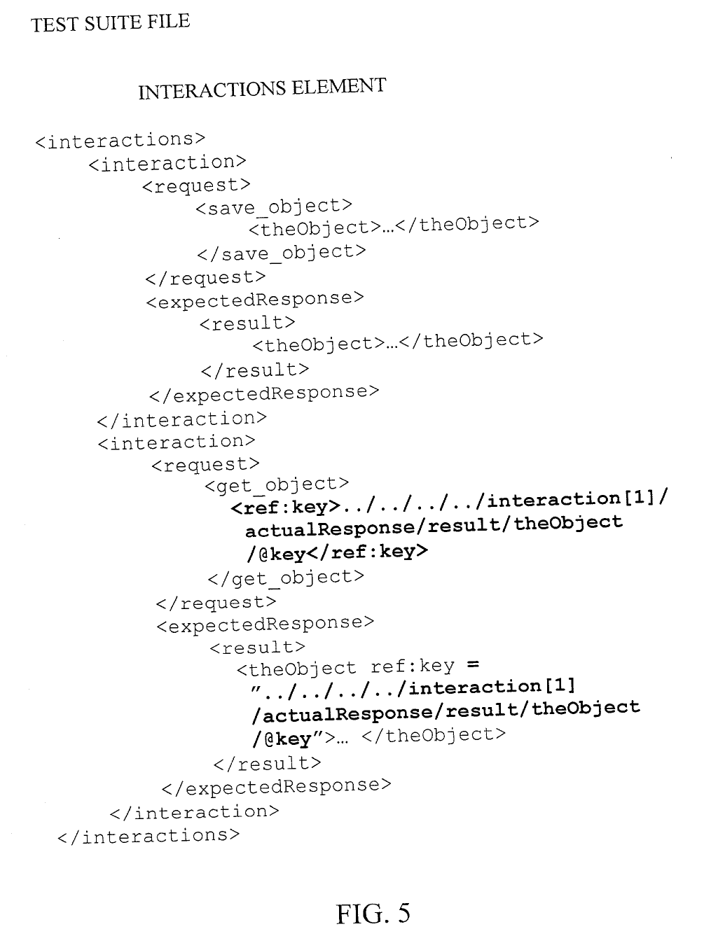

FIG. 5 illustrates an exemplary test suite file that includes interaction elements. The test suite file is written in XML. XML consists of elements, attributes, and text. Examples of these are provided as follows: An empty element: “<TagName/>” or “<TagName></TagName>”, an attribute in an empty: “<TagName AttrName=”attr value”/>”, and an element containing text “<TagName>The text</TagName >”.

An integral part of XML is its containment relationship. Elements contain attributes and other elements. In this example: “<Tag1 Attr1=”value1”><Tag2/></Tag1>”, the element “Tag1” contains an attribute “attr1” and an element “Tag2”. Attributes contain only text values. There is no limit on the number of contained elements or the depth of containment. Attributes contained in an element are required to have unique names, but elements do not share this restriction.

An XML document has only one root element. There are also certain rules about how and where to use “<”, “>”, and “/” characters. Elements if they contain no text or other elements can have the form “<TagName/>” or “<TagName></TagName>”. Elements that have contents must be of the form “<TagName>contents</TagName>”. The first tag is called the beginning tag and the other tag is called the ending tag.

Tag names must match exactly according to character and case. Text may not contain “<” or “&” characters; if such characters are desired they need to be replaced with “&gt;”and “&amp;” respectively.

A walk-through of the processing performed by the present invention is now described. First, the test suite document is parsed into a DOM, which is a standard way to programmatically represent XML documents internal to a program. As described previously, the mechanisms of the present invention modify the internal representation of the document. Similarly, the modifications, replacements, and insertions in the exemplary test document illustrated in FIGS. 5-9 represent changes and modifications to the internal representation of the document and not to the document itself. It is noted that the test document is not modified by the mechanisms of the present invention.

In this example, there are two iterations since there are two interaction elements in the interaction section. The first interaction generates a save request, and the second interaction generates a get request.

Iteration 1—Step 1

Since the save request has no “ref:” elements or attributes, no processing is performed in step 1.

Iteration 1—Step 2

The request is sent to the server. The mechanism for sending requests to servers is well-known to those of ordinary skill in the art. In the case of UDDI, requests are sent using HTTP or HTTPS POST. The body of the POST contains a SOAP envelope and body that contains the contents of the request element. In this case, an exemplary request can be in the following form:

<save_object>

<theObject>...</theObject>

</save_object>

Iteration 1—Step 3

HTTP POST returns a response that includes data. This data can be in the form of a SOAP XML document containing a SOAP envelope and body. The body includes the actual response data, which is of interest.

Iteration 1—Step 4

A new element is created and given the tag name “actualResponse”. The “data of interest” from step 3 is added to this new element.

Iteration 1 Step 5

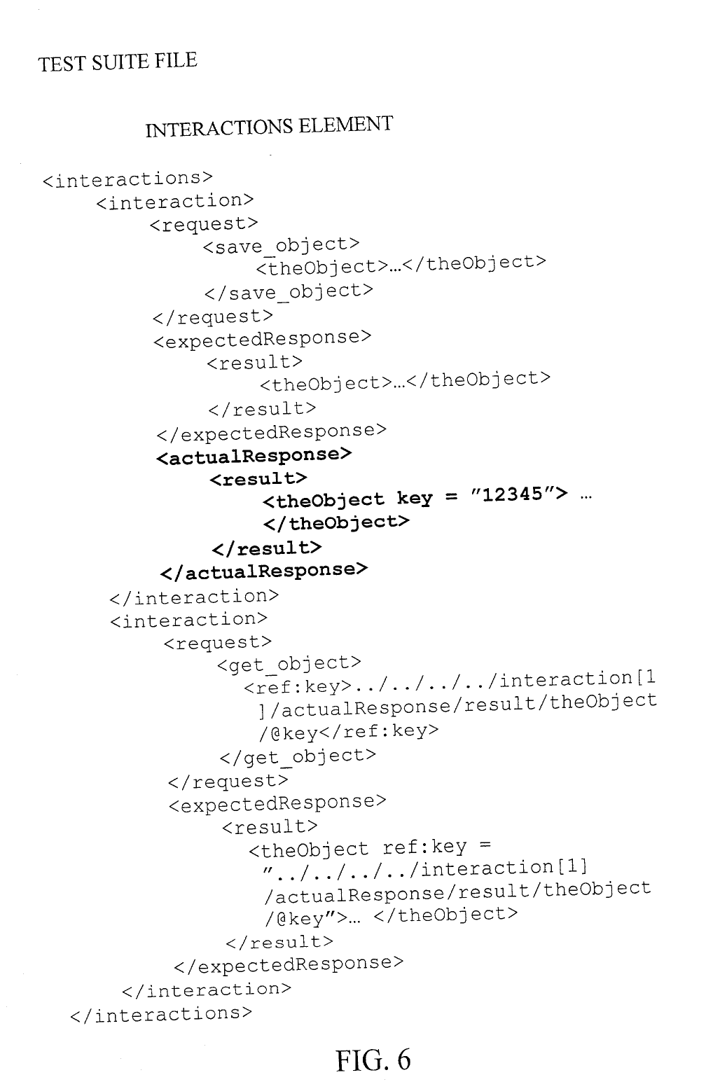

This new actualResponse element is then inserted into the document just below the expected response. FIG. 6 illustrates the test suite file of FIG. 5 with the actualResponse element added thereto.

Iteration 1 Step 6

In this iteration, this step is uninteresting since there are no ref: attributes or elements to replace.

Iteration 1 Step 7

Comparison of the two documents is now performed. A comparison algorithm may be applied to both of the documents. The comparison algorithm tests the two documents for equality and returns a failure if they are not equal.

Iteration 1 Step 8

If for some reason the comparison determines that the two documents are not equal, the test is stopped.

Iteration 2 Step 1

The algorithm for this step (as well as step 6) is defined in the algorithm called “replace references” described previously. The algorithm involves traversing the request element (e.g., the DOM tree) in order to search for nodes or attributes with names beginning with an insertion tag (e.g., “ref:”). When nodes or attributes with the “ref:” tag are found, the contents of such nodes or attributes are treated as an XPath relative to the current node. This XPath leads us to another node.

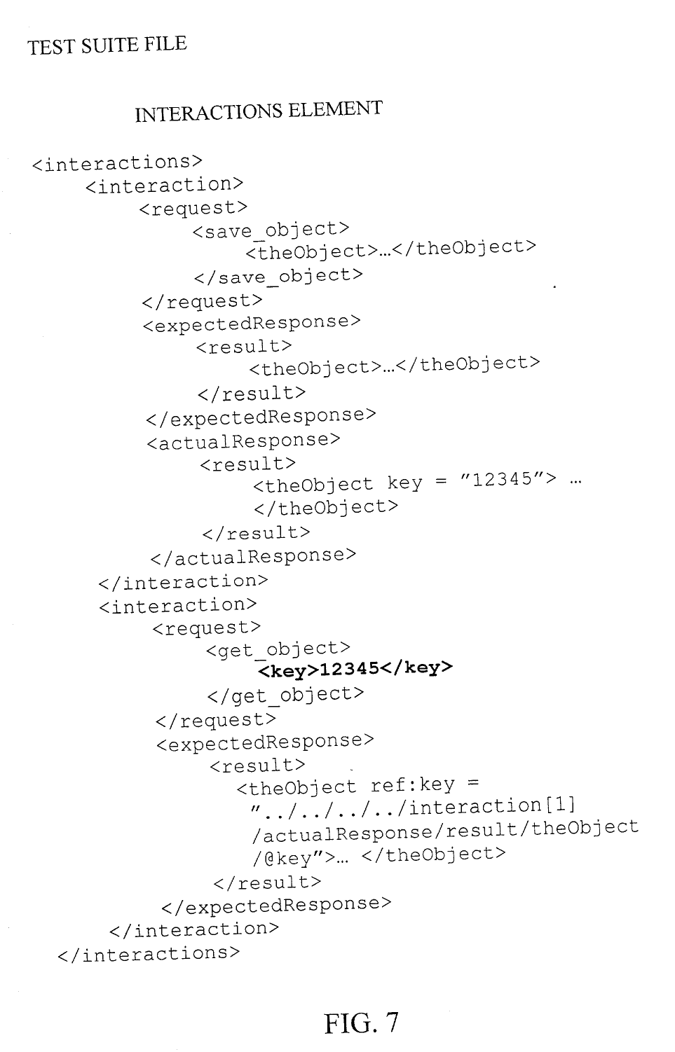

These nodes, as described above, are utilized to replace the “ref:” node with a new node based on the contents of the referenced node. FIG. 7 illustrates the test suite file of FIG. 6 after an expected response element has had its references replaced with a key value obtained at run-time according to one embodiment of the present invention.

Iteration 2 Step 2

A request is sent over HTTP or HTTPS.

Iteration 2 Step 3

A response is received.

Iteration 2 Step 4

An actualResponse element is created.

Iteration 2 Step 5

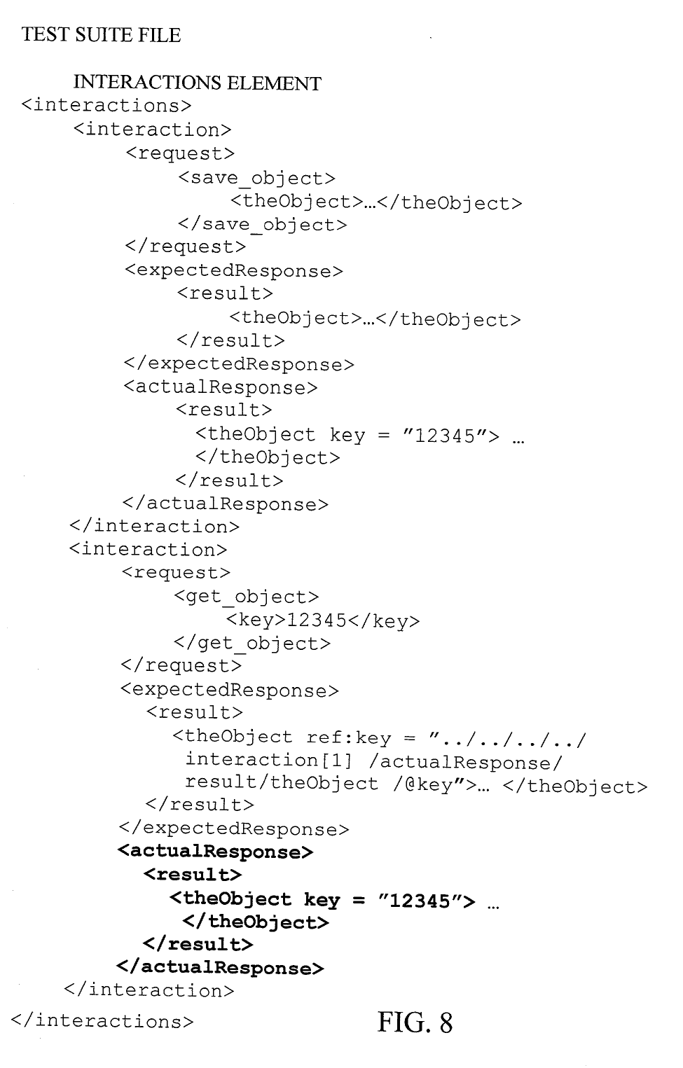

The actualResponse element is added to the document. FIG. 8 illustrates the test suite file of FIG. 7 with the actualResponse element added to the second interaction element.

Iteration 2 Step 6

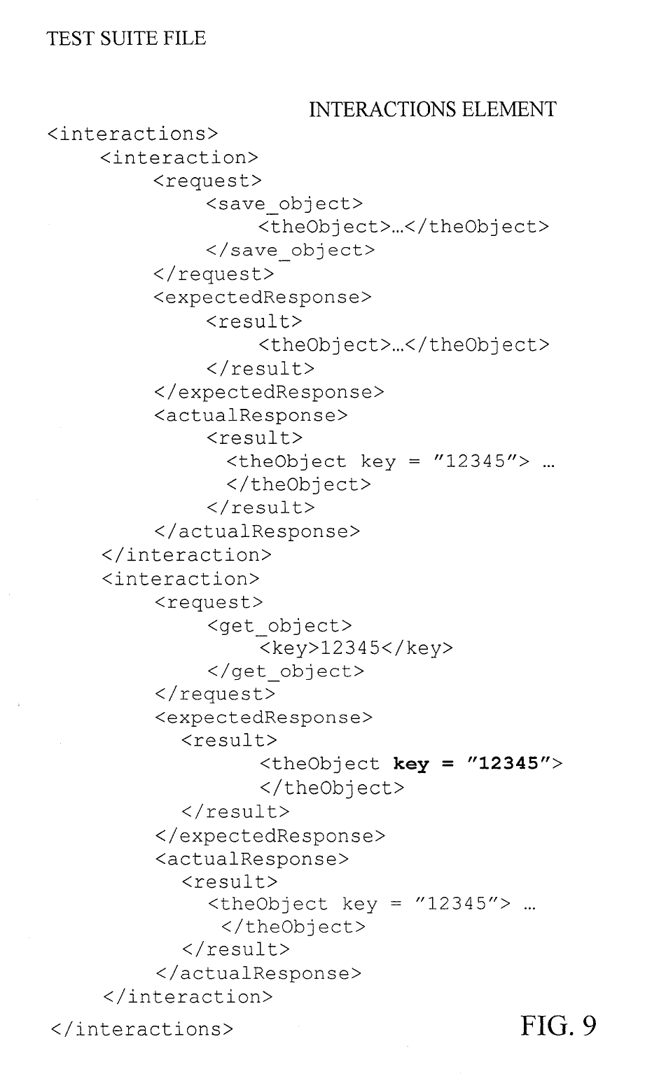

In this step, the algorithm of step 1 is performed except in this case we traverse the expectedResponse (e.g., DOM tree). FIG. 9 illustrates the test suite file of FIG. 8 with its internal representation changed to reflect the key attribute value obtained at run-time.

Iteration 2 Step 7

The actual and expected responses are compared.

Iteration 2 Step 8

If for some reason the comparison determines that the two documents are not equal, the test is stopped.

The principles of the present invention are described in the context of a real-time method for embedding XML fragments into XML documents. However, it is noted that the teaching of the present invention can be applied to any structured document and other applications. It is noted that other technologies may be utilized to reference another portion of the same structured document.

One advantage of the present invention is that the mechanism of the present invention allows a test file or suite to be written that refers to or uses information that is unknown until run-time.

Another advantage of the present invention is that test files or suites may be shortened by using a reference to another portion of the same test file instead of having to copy or duplicate the portion of same test code in multiple places in the same document. For example, since the results of both the “save” and “get” calls, in UDDI, are essentially the same, and the expected result is fully specified in the “save” call, the expected response in the “get” call can simply make a reference to the save's expected response by utilizing the mechanisms of the present invention. One advantage of this approach is that the test files may be simplified and shortened by using references to another portion of the test file in lieu of repeating or duplicating that portion of the test file (e.g., expected responses).

In the foregoing specification, the invention has been described with reference to specific embodiments thereof. It will, however, be evident that various modifications and changes may be made thereto without departing from the broader scope of the invention. The specification and drawings are, accordingly, to be regarded in an illustrative rather than a restrictive sense.

What is claimed is:

1. A method for dynamically modifying a mark-up language document during runtime comprising the steps of:
a) providing an insertion tag for use in the mark-up language document; wherein the insertion tag specifies a location in the mark-up language document for inserting data that is unavailable when the mark-up language document is created;
b) receiving a mark-up language document that includes at least one set of insertion tags;
c) receiving data during run-time; and
d) dynamically modifying at run-time the mark-up language document with the received data.

2. The method of claim 1 wherein the step of dynamically modifying at run-time the mark-up language document with the received data includes the step of injecting the received data in the mark-up language document at the location specified by the insertion tags.

3. The method of claim 1 further comprising the step of:
e) using the received data in another portion of the mark-up language document.

4. The method of claim 1 wherein the mark-up language document is an XML document.

5. The method of claim 4 wherein the XML document is an XML test suite file.

6. The method of claim 1 wherein the step of dynamically modifying at run-time the mark-up language document with the received data includes the steps of
parsing the mark-up language document to generate a representation thereof; and
modifying the representation with the received data.

7. The method of claim 6 wherein the step of modifying the representation with the received data includes the steps of
creating a new node that includes the received data;
adding the new node to the representation; and
removing the insertion tag from the representation.

8. A method for dynamically modifying a mark-up language document during runtime comprising the steps of:
receiving a mark-up language document that includes at least one injection tag for specifying a location in the mark-up language document to inject information that is not known at the time that the mark-up language document is created;
generating a representation of the mark-up language document that includes a tree structure;
receiving information; and
injecting the information at the location specified by the injection tag.

9. The method of claim 8 wherein the step of injecting the information at the location specified by the injection tag includes
creating an actual response node;
populating the actual response node with information from the response;
adding the actual response node to the representation of the mark-up language document.

10. The method of claim 8 wherein the step of receiving information includes
receiving information from a response during run-time.

11. The method of claim 8 wherein the step of injecting the information at the location specified by the injection tag includes
injecting the received information into an internal representation of a mark-up document.

12. The method of claim 11 wherein the internal representation is one of a DOM representation, an XML tree, and other representations.

13. The method of claim 8 wherein the injected information is subsequently utilized during run-time as one of a part of a call and a part of a request.

14. The method of claim 13 wherein the request is a save request in UDDI.

15. A method for testing a Web server comprising the steps of:
a) generating a test suite file written in a markup language that includes at least one injection tag; and
b) at run-time receiving data that is unavailable when the test suite file is generated and modifying a representation of the test suite file with the received data.

16. The method of claim 15 further comprising the steps of:
c) using the received data in another portion of the test suite file.

17. A test infrastructure for interacting with a server that has capabilities comprising:
a) a test suite for use in testing the capabilities of the server; wherein the test suite includes an expected response for a first request and at least one reference to information not known to a tester when preparing the test suite; and
b) an injection module for receiving information from the server, for generating an actual response based on the received information, and for replacing the reference with a target in the actual response that is referenced by the reference.

18. The system of claim 17 further including:
c) a comparison module for comparing an actual response with an expected response.

19. The system of claim 17 further including:
a parser for receiving the test suite and generating a DOM representation of the test suite.

20. The system of claim 17 wherein the injection module further includes:
a node creator for creating a new node with the received information; and
a node adder for adding the newly created node to a representation of the test suite.
